(19) United States
(12) Patent Application Publication
(10) Pub. No.: US 2014/0242558 A1
(43) Pub. Date: Aug. 28, 2014

(54) Bartender Training Method and Apparatus

(71) Applicant: Mark Daragjati, Staten Island, NY (US)

(72) Inventor: Mark Daragjati, Staten Island, NY (US)

(21) Appl. No.: 14/188,182

(22) Filed: Feb. 24, 2014

Related U.S. Application Data
(60) Provisional application No. 61/768,092, filed on Feb. 22, 2013.

(51) Int. Cl. G09B 19/00

(52) U.S. Cl. CPC G09B 19/00
USPC 434/219

(57) ABSTRACT

A bartender training method and apparatus is provided, wherein the same can be deployed as a training course adapted to train users the art of mixology and efficient bartending skills. In an exemplary embodiment, the present invention contemplates one or more bar stations set up for making and serving mixed drinks, wherein each bar station comprises an interactive display screen and a slop bin to receive prepared drinks. The interactive display screen prompts each user with drink orders of varying complexity, whereby drink details may be provided for beginning learners and more difficult commands and routines are requested as experience is gained. Upon course completion, user performance data is used for grading purposes and for providing the user with a profile to show would-be employers. The present invention improves current methods of bartending training and emphasizes speed and efficiency of drinking making.

### CROSS REFERENCE TO RELATED APPLICATION

This application claims the benefit of U.S. Provisional Application No. 61/768,092 filed on Feb. 22, 2013. The above identified patent application is herein incorporated by reference in its entirety to provide continuity of disclosure.

### BACKGROUND OF THE INVENTION

1. Field of the Invention

The present invention relates to bartender and mixology teaching methods and tools therefor. More specifically, the present invention relates to a new method and apparatus for teaching bartenders and bartenders in training how to make drinks in rapid succession and in a high stress environment such as found in commercial bars and night clubs, wherein the method and apparatus can be deployed in course with several participants. Also provided is a method of cataloging and tracking performance of each course participant for subsequent reference after course completion for job marketing purpose.

Traditional methods of learning bartending and mixology skills generally evolve over a period of on-the-job training or through attendance in one or more bartending academies or classes. The latter approach involves students learning to mix various drinks during an instructor-taught course, whereby students are first taught the ingredients to common drinks, and thereafter the entire class participates in active drink-making activities. Students are taught using some hands-on learning techniques and through classic study/memorization techniques.

While the traditional bartending course technique is useful for some, the pace of the class and thus the scope of the learned material is placed in the hands of the slowest students. Drink mixing sessions are generally taught by an instructor who calls out a drink order, whereafter the class participants each mix the drinks to fulfill the order via memory or after referencing the ingredients. The quicker students are therefore held back by slower or less competent participants.

Moreover, and more salient to establishment owners, is the fact that traditional bartending courses lack the quality of teaching the real-world stress involved with commercial bar or night club environment. There exists a gap between bartenders who have learned through traditional methods and those bartenders who have experienced working in a fast-paced, high pressure bartending environment where a premium is placed on efficiency and drink making speed. The ability to recall drink ingredients on demand is but one aspect of operating as a bartender in a more crowded and high demand environment, where many patrons may be requesting drinks simultaneously and each may have several orders at one time.

The present invention is designed to bridge the gap between a novice bartender and one who is capable of handling the stress and speed of a busy night club bar where the volume of orders is drastically increased over normal settings. The present invention provides a method and a new teaching apparatus that are adapted to be deployed in a new bartending course, whereby participants of any skill level can be incrementally taught to remember drink ingredients, and furthermore be able to fulfill several orders in succession and by memory by the completion of the course. The course comprises a unique bar station that involves an interactive display that provides input to the participant and information about each drink (if necessary), and furthermore allows drink orders to be filled and then deposited in a slop bin thereafter. This eliminates the need for a second person to accept the drinks, and provides the participant with a simulation of the bar environment where drinks are fulfilled and distributed with efficiency and speed in mind.

Overall, the present invention is well suited for implementation as a course that will produce bartenders of high quality and well suited for the busiest bar environments. These environments include establishments that benefit from efficient service and high volume output. Upon completion of the course, each student undergoes a course-ending crucible that involves a high volume of drink order exercise with a short time window allotment, wherein the exercise is video recorded. It is contemplated that each participant, after course completion, may be able to access their course performance metrics and provide would-be employers with access to their performance and the video of their final performance. In this way, the present invention produces high quality bartenders and boosts the marketability of participants seeking employment in nightclubs and commercial bars.

2. Description of the Prior Art

Devices have been disclosed in the prior art that relate to bartending and mixology teaching tools. These include devices that have been patented and published in patent application publications, and generally relate to kits and other in-home teaching devices and courses that teach drink ingredients or pouring accuracy. No device contemplates a course using an interactive drink order display and a bar station, as well as a method that teaches both drink making skills and drink making speed using hands-on training techniques. The following is a list of devices deemed most relevant to the present disclosure, which are herein described for the purposes of highlighting and differentiating the unique aspects of the present invention, and further highlighting the drawbacks existing in the prior art.

One such drink-making reference tool in the prior art is U.S. Patent Publication No. 2006/0273178 to Tsang, which discloses a portable reference tool for making mixed drinks, wherein a stack of cards is provided attached to a common key ring. The cards each have a reference to a given drink, the drink ingredients, and instructions for mixing the given drink. The assembly is adapted to provide a quick reference guide for a new bartender or individual when making mixed drinks of different kind. While providing a reference tool, the Tsang device does not engage the user with an interactive and automated ordering system, and further does not teach the user to take drink orders and fill the same in high pressure environments.

Another device is U.S. Patent Publication No. 2011/0318718 to Duffy, III, which discloses a bartending kit and method of self-teaching individuals the art of mixology using a minimum investment in alcohol and supplies. The kit comprises a small subset of drinkable alcohol bottles and a teaching method that utilizes this small subset to teach the user how to make many drinks with typical mixology tools and only the types of alcohol provided in the kit. A viewable video (instructional DVD) is provided for teaching the user how to operate the mixology tools and to mix the drinks with the given alcohol in the kit. The Duffy, III kit and method, while providing a cost-effective means of teaching would-be bartenders and mixologist how to make many common drinks, fails to provide an interactive teaching tool that prompts the user to fill drink orders in a high intensity drill, where both mixology and drink order efficiency are learned for those that would like to work in a commercial bar setting.

U.S. Pat. No. 6,866,511 to Harris discloses an electronic device for preparation of mixed drinks, wherein the device provides a memory and a display screen for displaying a type of drink and the contents of that drink. The device further comprises a handle supporting a measuring container that can be used to dispense measured quantities of alcohol thereinto when making the selected drink. The container is then emptied into a glass, the type of which is also displayed for the user by the device. In this way, the electronic device of Harris provides a means of accurately measuring the ingredients of a mixed drink, while also providing the user with an ingredient list for given drinks for the purpose of teaching or jogging the memory of the user. The Harris device provides a physical means of measuring drink ingredients and a display of those ingredients. The present invention is directed to a method of teaching bartenders or those in bartending academy how to prepare drinks in a fast paced environment using an interactive display and a bar station that is fully equipped and well suited for the purposes of the method.

Finally, U.S. Pat. No. 4,482,327 to Brady discloses a training tool for bartenders and the like that tests the ability of the user to free pour drinks in measured quantities and judge their accuracy with respect thereto. The device comprises a plurality of graduated containers supported by a frame, wherein gradations along the side of the containers correspond to volume indications. Secondary graduations are provided for indicating a margin of error with respect to primary graduations, which are measured in excess of liquid poured into the containers. An accompanying score sheet and testing method is disclosed for comparing scores of a user and between different users when free pouring. As with the aforementioned prior art devices, the Brady device fails to contemplate the nature and goal of the present invention, and further does not disclose the method steps or necessary elements of the bar station of the present invention. The Brady device is a free pour measuring assembly used to ensure bartenders are dispensing accurate quantities of alcohol and mixers for accounting purposes and to ensure proper mix ratios for drinks.

The present invention provides a new and novel training course for beginners and for experienced bartenders, where drink mixing knowledge and drink mixing proficiency are both taught using a unique method and bar station apparatus. The present invention is well adapted for use in a training course with several student participants, wherein each is provided a bar station and each is provided an interactive display in which to receive training instructions and drink orders. This eliminates instructor directions to the entire class, and individualizes the learning during certain periods of the course. Overall, the present invention is disclosed as a new method of teaching bartending skills. It is submitted that its apparatus elements and methodology are substantially divergent from those tools in the prior art, and consequently it is clear that there is a need in the art for an improvement to existing bartending training methods. In this regard the instant invention substantially fulfills these needs.

### SUMMARY OF THE INVENTION

In view of the foregoing disadvantages inherent in the known types of bartending training methods now present in the prior art, the present invention provides a new training method and unique bar station apparatus that can be utilized for teaching drink mixing skills in using a hands-on and individualized approach, wherein drink mixing knowledge is quickly advanced and proficiency in a high pressure bartending environments is taught.

It is therefore an object of the present invention to provide a new and improved bartender training method that has all of the advantages of the prior art and none of the disadvantages.

It is another object of the present invention to provide a bartender training method that employs a unique bar station, equipped with all the tools necessary to make mixed drinks and cocktails, while also providing an interactive display to prompt the user for drinks and a slop bin for receiving prepared drinks.

Another object of the present invention is to provide a bartender training method that employs interactive displays that teach drink ingredients, drink making efficiency, and provide timed exercises for a user.

Yet another object of the present invention is to provide a bartender training method that employs a system capable of tracking and cataloging a user's performance during the course for tracking improvements and for evaluating the user upon course completion.

Another object of the present invention is to provide a bartender training method that allows access to the user's performance to outside employers, whereby the user can provide access to an online account for which a would-be employer can verify the skills of the individual by way of his or her performance metrics and via an accessible drill that is recorded and stored on the system.

Another object of the present invention is to provide a bartender training method that can be employed across the country and provided to a team of participants in a group course environment.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a view of the bartending station of the present invention.

FIG. 2 shows a plurality of bartending stations aligned in a row as would typically be arranged in a training course deploying the present method.

FIG. 3A shows a view of the interactive display screen of the present invention.

FIG. 3B shows another view of the interactive display screen of the present invention.

FIG. 4 shows sample method steps for a training sequence using the bar station and interactive display screen of the present invention.

FIG. 5 shows a system view of the present invention, in which the performance of each course participant can be tracked and stored for subsequent retrieval and evaluation.

### DETAILED DESCRIPTION OF THE INVENTION

Reference is made herein to the attached drawings. Like reference numerals are used throughout the drawings to depict like or similar elements of the bartender training method of the present invention. For the purposes of presenting a brief and clear description of the present invention, the preferred embodiment will be discussed as used for training bartenders to memorize drink ingredients and learn efficient bartending skills while under duress, whereby those skills are translatable into real-world skills in a bar or nightclub environment. The figures are intended for representative purposes only and should not be considered to be limiting in any respect.

The present invention comprises a new bartending method and unique apparatus therefor, wherein the method involves the use of an interactive and personalized drink order display screen and the apparatus allows users to learn bartending skills while maintaining an uncluttered work space. The method is deployed in a bartending course environment, where one or more participants enter the class to learn the basics of bartending (i.e. drink mixing and ingredients) and how to be an efficient bartender under real-world conditions. Specifically, the method teaches a participant how to fulfill a drink order from memory and using repetition, whereby the goal of the course is to produce bartenders skilled in the art of mixing drinks, and more specifically bartenders who can handle a high volume of drink orders over a short period. Graduates of the course are able to work in high volume nightclub environments where many patrons may be ordering simultaneously and speed is a virtue. Once completed, the performance of the participant can be graded or measured, and the participant's performance can be accessed by outside bar owners if the participant so desires to compliment his or her resume.

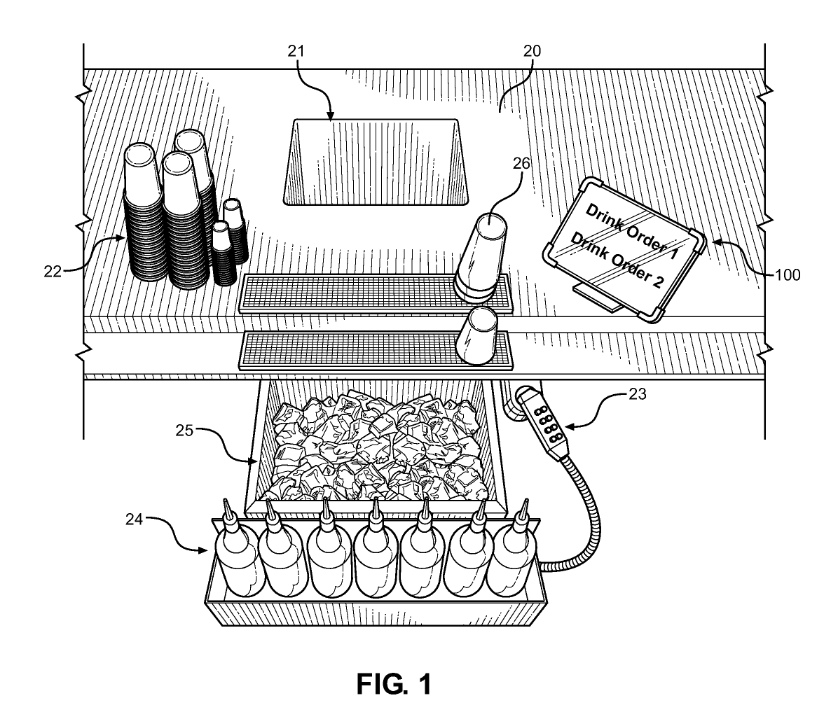

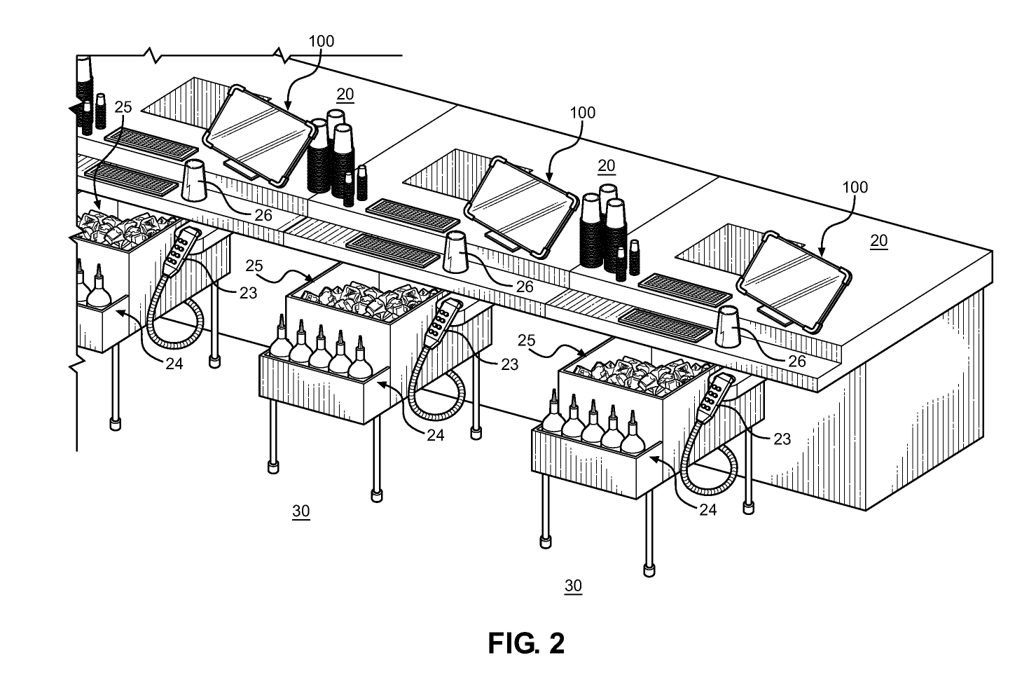

Referring now to FIGS. 1 and 2, there is shown a view of the bar station apparatus of the present invention. FIG. 1 shows a single bar station, while FIG. 2 illustrates how several bar stations can be aligned during a training course where several course participants are learning at once. The bar station of the present invention is adapted to resemble the work area of most commercial bars and include all of the necessary items to fulfill orders and learn the craft in a hands-on manner. Notably, the bar station comprises a bar surface 20, one or more mixable liquids 24, one or more servable liquid containers 22, an interactive display screen 100, and a slop bin 21. The bar surface 20 is used to simulate a real bar and provides an area upon which to fulfill drink orders. The one or more mixable liquids 24 may comprise several different alcohols or mixers that are commonly used to prepare mixed drinks and cocktails, while the servable liquid containers 22 comprise one or more different style drink glasses or cups that the bartender must choose from depending on the drink type (i.e. pint glasses, shot glasses, martini glasses, plastic cups, etc.)

Below the bar surface 20 is preferably located an ice bin 25, adjacent to the mixable liquids 24 and a post-mix bar gun 23. The bar gun 23 is a common tool in the art that dispenses water, juice, or post-mix beverages as the bartender is preparing a mixed drink. The bar gun is well understood in the art of commercial restaurants and bars. The bar station may further comprise other drink making tools, including ice shakers 26, storage vessels for drink garnishes, and other common bartender station tools. The goal of the station is replicate a common bar area and provide the student participant with an environment that will be very similar to one in which he or she will see when working in the field.

The interactive display screen 100 preferably comprises a tablet computer having a touchscreen surface. The screen 100 is supported by a tablet support along the bar surface 20 such that the screen 100 is directed at the user behind the bar and is within reach such that the user can readily reach and touch the screen 100 when necessary. The display screen 100 is the driver of the course, as opposed to traditional classes in which an instructor provides prompts for the user. The display screen 100 is a tablet with a program thereon that is adapted to engage the user and prompt the user with a series of drink orders, while also providing additional details related to the drink order if necessary. The program is described in the present method, which puts the user through a series of exercises to build confidence, drink mixing knowledge, and improve efficiency and speed with which the user can fulfill drink orders. The user interacts with the screen 100 to move from one part of the course to the next and from one set of commands to another, whereby metrics and performance is tracked using the interaction as a means to show start times/completion times and knowledge progression.

When in use, the user stands behind 30 his or her designated bar station and is prompted for drink orders or similar commands via the interactive display screen 100. The user can then fulfill the drink order or follow the commands using the tools of the bar station. Of great importance in some of the exercises is the ability to simulate the speed of drink fulfillment and patrons taking away the drinks after they are made. The bar station of the present invention, rather than using a second individual or having the bar surface 20 become cluttered with filled orders, provides a slop bin 21 along the bar surface 20 and forward of the standing position 30 of the user. The slop bin 21 comprises a sink within the bar surface 20, wherein the user can first fulfill the drink order and then slide the made drinks into the slop bin 21 to clear the area for a new order. In this way, the user is learning to make drinks and distribute them as if there were patrons along the opposite side of the bar surface 20 to remove the drinks. The slop bin 21 comprises an open upper and a sink lower, wherein the slop bin 21 may further comprise a liquid drain. At a minimum, the slop bin 21 comprises a receptacle for made drinks, and in exemplary embodiments connects to a liquid drain to allow drinks to drain from the slop bin 21 interior.

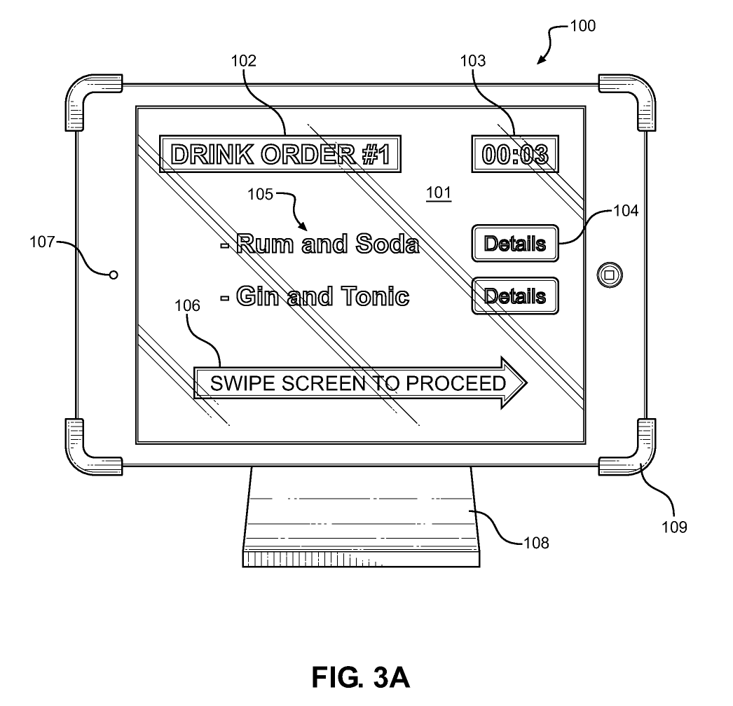

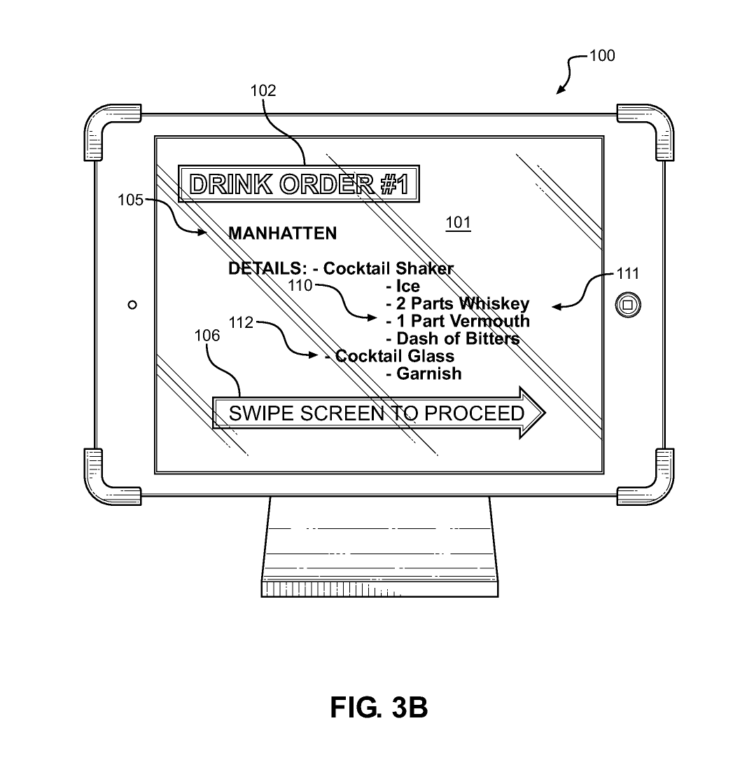

Referring now to FIGS. 3A and 3B, there is shown the interactive display screen 100 of the present invention and example commands given to the user during a bartender training course. The display screen 100 preferably comprises a tablet computer having a touchscreen display 101, a processor, memory, storage, and wireless antenna; however the screen 100 may alternatively comprise a touchscreen monitor that receives instructions from a remote computer. Use of a touchscreen tablet is most convenient, wherein the tablet is supported by a tablet stand 108, 109 along the bar surface and runs an application layer that walks the user through various drink mixing drills. It is contemplated that the bartending course of the present invention culminates in a final drink mixing drill that is over an extended period and include many drink orders. It is further contemplated that this final drill is videotaped for posterity and for use as a resume supplement for a future employer to reference. The recording may be accomplished using the video recorder 107 along the tablet, or alternatively external video recorders may be deployed (i.e. handheld video recorders, personal recorders attached to the user, wearable glasses with recorders thereon for a first-person perspective, etc.). Further details regarding this final drill and the recording operation are provided below.

During each training session, the drills become more difficult and the amount of reference information provided to the user is reduced, thereby starting slow and gradually making the student have to recall from memory the details of each drink and moreover, remember drink orders that appear for only short durations. On the interactive display screen 100, it is contemplated that a series of commands are given to the user, which may include drink orders or other commands such as filling glasses with ice as fast as possible during introductory rounds of training. FIGS. 3A and 3B show two different command screens, wherein a series of drink orders 102 is given to the user and he or she fulfills the order and swipes the screen 106 to proceed to a subsequent drink order. Each drink order request can be timed 103, as well as the overall exercise, and this timer 103 may or may not be shown to the user.

Each drink order comprises the name of the drink request 105 and may include further information, depending on the complexity level and the stage of training in which the user is currently in. As shown in FIG. 3B, in the early stages of training, a drink order may comprise a single drink request by title 105, and may include all ingredients 110 and steps 111 to make the drink. This includes the required mixable liquids 110, the steps 111 to make the drink (e.g. mix in a shaker, etc.), and the type of glass 112 within which the drink is commonly served. This type of command assumes the user is at an introductory level and requires all necessary steps to make the drink. After making several drinks and passing the early stages of training, it is desired to provide less information about each drink and to increase the difficulty level for the user. The difficulty level can be increased by providing less information about each drink, increasing the drink order size, increasing the number of drink orders, and even providing a drink order that is only temporarily displayed to user. The latter makes the user quickly read the drink order and rely on his or her memory to fulfill all of the drinks in the order, as would normally occur in a real-world environment. Finally, in intermediate drills, the user may be prompted for several drinks and be offered a “Details” option 104, wherein the user can access a screen that displays all of the ingredients for the specific drink when required. This is useful as the user transitions from learning ingredients to making the same from memory alone, thereby providing a crutch for the user if he or she forgets certain drink details.

The method of the present invention is a bartender training course and the use of an interactive display screen to run an application layer instructing individual students and guiding the same through various drills and exercises. The method preferably employs the bar station of the present invention and includes various commands that the user fulfills during the course. The use of an individualized display screen and a bar station for each student allows the students to progress through the course at their own pace and not be limited by the slowest course participant. In this way, novice drink makers to more experienced bartenders can take the course and move through the various levels of difficulty at their own pace, whereby novices will struggle learning drink ingredients, while more experienced bartenders can focus on the skills of efficient drink making, where speed is prized.

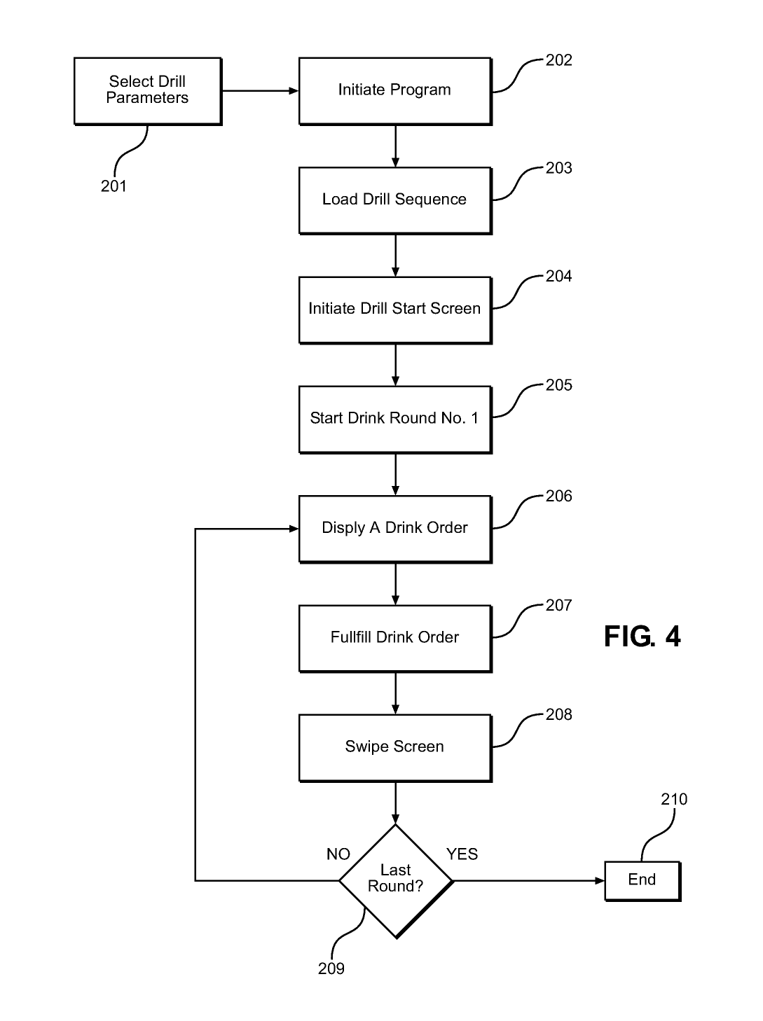

Referring now to FIG. 4, there is shown a contemplated flow diagram for each drill of the present method, wherein the exact details of the drill and the level of difficulty can be adjusted within this sequence. The first step involves selecting the drill parameters 201, which may be determined by an administrator of the course based on the user skills and the desired metrics that will be logged during the given drill. In this step, the level of difficult is chosen and the starting point for the user is decided (i.e. novice, intermediate, skilled levels). The drill program is initiated 202 by the administrator on the interactive display screens prior to the drill commencing. The exact drill details can then be loaded 203 prior to a starting screen appearing 204 for the user initiate the drill. The drill is preferably initiated by a swipe or tap of the touchscreen, which commences the drill, whereby a series of commands are provided for the user, who fulfils the commands and interacts with the screen to advance the drill to completion.

Overall, the method comprises providing one or more participants (course attendees) with a bar station having a bar surface, one or more mixable liquids, and one or more servable liquid containers. The bar station is also provided with an interactive drink order display screen, which the participant (user) can interact with during the drill sequences. Each drill is initiated using the display screen, whereby a training session comprising one or more commands is displayed 206 on the interactive display screen. The user then fulfills 207 the one or more commands displayed on the display screen and then interacts 208 with the display screen to mark completion of the commands, whereby the interaction marks 209 a request a succeeding command until the end of the drill sequence. This is repeated until the training session is completed 210, whereafter the performance of the user can be logged for tracking performance and for building a portfolio for subsequent reference.

Prior to the drill sequence commencing, the drill parameters are setup. This involves selecting the sequence parameters based on the ability of said participants. The parameters may comprise one or more of the following: the drink order difficulty level, the number of orders per command, the total number of commands per drill sequence, any timer parameters, what metrics are to be logged, and the duration of command display after initial displaying thereof. The latter gives the administrator the ability to temporarily display a drink order for more experienced participants, wherein the drink order remains visible for a short period of time and vanishes thereafter, whereby the user has to rely on his or her memory to fulfill the order.

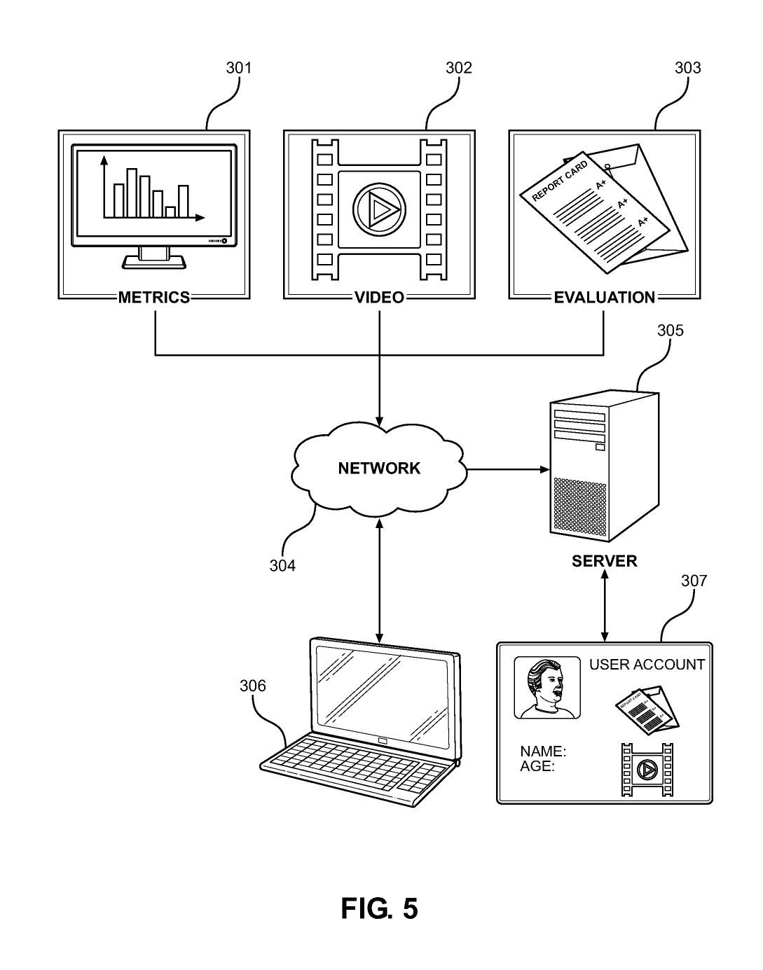

After each drill sequence and over the duration of the course, metrics from the sequence and the performance of the user can be logged and saved into a database. Referring now to FIG. 5, there is shown a view of the system that may be employed to track each course participant's performance, including performance over each drill sequence and overall performance tracking from course beginning to graduation. The system preferably comprises a server 305 and a network 304, over which the metrics from each bar station (tablet computer) can be logged and saved in a database on the server. Each of the course participants has a user account, wherein his or her performance can be tracked and used to grade the user upon course completion, or at a minimum show his or her improvements in bartending ability.

In an exemplary embodiment, it is desired to end the course with a final test sequence, wherein a series of drink orders are given to the user over a specified period and the sequence is video recorded for posterity and for subsequent review. A third party can support the camera, or a camera may be deployed on the user to obtain a first-person perspective. The video shows the proficiency of the user after completion of the course, whereby the speed and skill of the user is visually documented. In still another exemplary embodiment, the user's performance metrics 301, the video 302, and the user's course evaluation 303 may be accessible over the network 304 to outside users via a computer 306. This is useful for providing would-b employers with access to the user account 307 of the user, and further providing access to the user's performance prior to, or after a job interview. In this way, the performance and video of the user acts as a supplement to a resume when interviewing for a bartending position.

Overall, the present invention discloses a new bartender training method and apparatus. The apparatus comprises a bar station, while the method employs the bar station and employs a training program that facilitates not only drink making skills, but also speed of drink making and mass order fulfilling skilling. The final test is contemplated to be a three minute drill involving eighteen separate orders. Upon course completion, a user will be well suited for operating in a fast paced night club environment where many orders are made and speed is important for the bartender and for the establishment. The student is taught to make the drinks as quickly as possible. During the course, once the student is finished making the drink, the drink is pushed into the slop bin and the student slides his or her finger across the display screen to load the next round of drinks. The hands-on training supplements drink mixing and other standard lessons taught in a bartending course. This enables a student to learn to mix drinks at his or her own pace instead of waiting for the teacher to call out specific instructions. The simulation further enables students to simulate a fast-paced bar or nightclub setting during their training. The use of “next slide” technique with the tablet system and the fast-paced simulations give students a metric to competitively measure themselves against each other while in training.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A bartending training apparatus, comprising:
at least one bar station;
said bar station comprising:
a bar surface;
one or more mixable liquids;
one or more servable liquid containers;
an interactive display screen adapted to display drink orders and drink details;
a slop bin adapted to receive liquid containers after being filled with said mixable liquids.

2. The bartending training apparatus of claim 1, further comprising a cash register.

3. The bartending training apparatus of claim 1, wherein said slop bin further comprises a sink within said bar surface, said sink further comprising a drain.

4. The bartending training apparatus of claim 1, further comprising an ice bin.

5. The bartending training apparatus of claim 1, further comprising a liquid dispensing bar gun.

6. The bartending training apparatus of claim 1, further comprising one or more ice shakers.

7. The bartending training apparatus of claim 1, wherein said interactive display screen further comprises a tablet having a touchscreen display, said tablet supported on said bar surface.

8. A method of training bartenders, comprising:
providing one or more participants with a bar station having:
a bar surface;
one or more mixable liquids;
one or more servable liquid containers;
providing said participants with an interactive drink order display screen;
initiating a training session comprising one or more commands displayed on said interactive drink order display screen;
fulfilling said one or more commands;
interacting with said interactive drink order display screen to mark completion of said one or more commands and to request a succeeding command;
repeating said fulfilling and interacting steps until said training session ends.

9. The method of claim 8, further comprising the steps of:
selecting said training session parameters prior to initiating said training session based on the ability of said participants;
said training session parameters comprising one or more of the following:
difficulty level of each drink order;
number of orders per command;
total number of commands;
timer parameters;
metrics to be logged;
duration of command display after initial displaying thereof.

10. The method of claim 8, further comprising the steps of:
logging metrics of said training session based on participant performance.

11. The method of claim 8, further comprising the steps of:
creating a participant profile on a database on a server;
logging metrics of each training session;
storing said metrics on said participant profile for subsequent retrieval.

12. The method of claim 11, further comprising the steps of:
providing access to said participant profile on said server via a network.

13. The method of claim 8, wherein said bar station further comprises:
a slop bin adapted to receive liquid containers after being filled with said mixable liquids.

14. The method of claim 8, wherein said step of interacting with said interactive drink order display screen comprises swiping the touchscreen of said interactive drink order display screen.

15. The method of claim 8, wherein said one or more commands each further comprise at least one of the following:
a drink order comprising drink names;
a drink order comprising drink names, drink ingredients, and serving instructions; or
a drink order comprising drink names with an interrogative button.

16. The method of claim 8, wherein said interactive drink order display screen further comprises a tablet computer having a touchscreen display.
